(19) United States
(12) Patent Application Publication
(10) Pub. No.: US 2012/0015208 A1
(43) Pub. Date: Jan. 19, 2012

(54) METHOD OF ACCOMPLISHMENT OF A HYBRID CORD

(75) Inventor: Miguel Lages Malafaya Oliveira Sá, Porto (PT)

(73) Assignee: MANUEL RODRIGUES D'OLIVEIRA SA & FILHOS, S.A., Paredes (PT)

(21) Appl. No.: 13/182,622

(22) Filed: Jul. 14, 2011

(30) Foreign Application Priority Data
Jul. 14, 2010 (PT) 105197

(51) Int. Cl. B32B 15/02; B32B 15/08

(52) U.S. Cl. 428/623; 428/380; 428/626

(57) ABSTRACT

The present invention relates to a method of accomplishment of a hybrid cord comprising an inner layer (1) in steel cord, an intermediate layer (2) in a high module and high toughness fibre and an outer layer (3) in a Polyolefin fibre. The present invention also refers to its application in an 8 (4×2) cords braided hybrid cable or any other type of hybrid cable presenting another construction, in braided or twisted cables.

### SCOPE OF INVENTION

The present invention relates to a method of accomplishment of a hybrid cord made up of three layers and elements:
steel in the inner layer
High module fibre and high toughness in the middle layer
polyolefin fiber in outer layer.

This cord can be applied to a hybrid 8 cords (4×2) braided cable or to any other type of hybrid cable with a different construction, in braided or twisted cables.

### BACKGROUND OF THE INVENTION

Mixed common cables are well-known used for lifting loads, comprising a core of steel cords or cables to support the load, and an outer layer of fibre mainly designed to protect the core.

From the known technique reference is made to U.S. Patent No. US2004/0069132 which disclosed a cable for applications to lifting heavy loads, which uses a mixture of Fibres of High Module and Tenacity, unlike the present invention that combines elements of steel and a Fibre of High Module and Tenacity. Principles are different in that each requires a different approach in balancing the different elements, as well as in manufacturing processes.

Several patents and other means describe methods of accomplishment and manufacture of mixed common cables.

### ADVANTAGES OF THE INVENTION

The application of hybrid braided cord in a hybrid cable, allows, comparatively to other common mixed cables or common steel cables, a better balance between cable weight reduction and greater cable flexibility is achieved, which allows this type of cable to be used in situations where another type of cable can not be used, such as lifting loads of deep ocean floor in great depth.

This advantage is obtained by replacing part of steel core for a fibre of high module and tenacity, which enables a substantial reduction in weight on the cable, while maintaining its density higher than that of water, or negative buoyancy, an essential characteristic for an hybrid cable with sea applications.

The high module and high toughness fibre contributes effectively to reduce the breaking load. In common mixed cables, fibre when applied outside the cable and/or cord has essentially a protective function (of steel), and when applied inside of the cable and/or cord (core) its contribution to the breaking load can be considered marginal. That is, its role is primarily of protection and weight reduction (by replacing part of the steel elements), and not load support.

The replacement of the cord core only made of steel by a steel+high fibre core of high module and tenacity allows the intermediate fibre also to have a role in supporting the load, since being a high module and high toughness fibre with mechanical characteristics near the steel, works in conjunction with the element in steel, also contributing to a reduction of weight due to its low density.

This substitution allows an increase in real breaking Force and the work Force, since by decreasing the weight of the cable it is possible to increase the load to be lifted. That is, associated with high resistance to rupture, low weight allows for a longer cable to lift the same load, or having the same cable length it is possible to lift a heavier load since the breaking length is superior (useful breaking force superior in relation to a common mixed cable, for two reasons: low weight and superior resistance to breakage).

With this structure, the braided hybrid cable, revealed by the present invention, compared with 8 (4×2) cords braided common mixed cables has the following advantages:
In a common mixed cable steel element makes up approximately 68% of the total weight of the cable, while in the hybrid cable steel element represents approximately 60% of the total weight of the cable, while high module and high toughness fibre represents only 17%;
The weight of this hybrid cable is less than 24%, compared to a common mixed cable;
In the hybrid cable, regarding the breaking force, steel element represents only 31% of the breaking force of the cable;
The breaking force is about two times higher than the breaking force of a common mixed cable of the same diameter.

This hybrid cable allows to reduce the weight and metal section, and thus to increase the minimum breaking force of approximately 2 times compared to a common mixed cable.

In cyclic loading tests with prototype a residual charge was obtained after 1000 cycles, about 15% higher than the average breaking load obtained in breakage test.

### BRIEF DESCRIPTION OF THE DRAWINGS

These and other features can be easily understood through the attached drawings, which must be regarded merely as examples and in any way restrictive to the scope of the invention.

FIG. 1 shows a cross-sectional view of the section of the cords that constitute the hybrid cable, being visible the disposal of several elements: cord core 1, intermediate layer 2 and outer layer 3.

FIG. 2 shows a cross-sectional view of the cords that constitute the hybrid cable, being visible several elements disposal: cord core 1, intermediate layer 2 and outer layer 3.

FIG. 3 shows a cross-sectional view of section of the hybrid cable 4 consisting of 4 cords with twist direction Z (right) 5 and 4 cords with twist direction S (left) 6.

FIG. 4 shows a cross-sectional view of the hybrid cable, in which a twist direction Z (right) 5 cords and a twist direction S (left) 6 cords are visible.

### DETAILED DESCRIPTION OF INVENTION

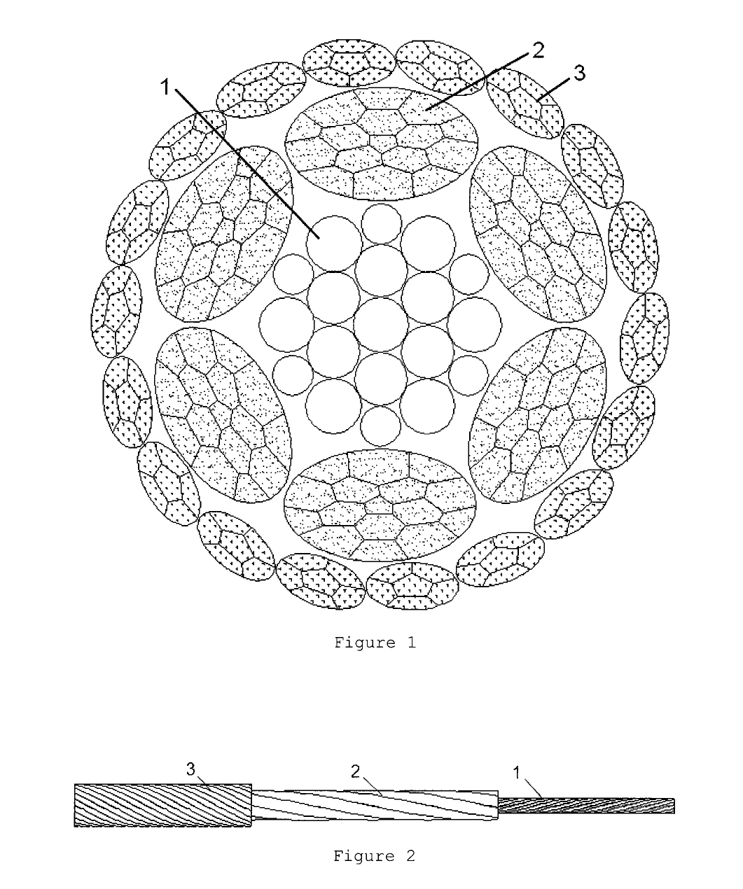

The present invention relates to a method of accomplishment of a hybrid cord made up of three elements and layers, as illustrated in FIGS. 1 and 2:
Core 1 for load support consisting of steel cord formed by steel wires
Intermediate layer 2 for load support consisting of a high-module and high tenacity fibre selected among HPME fibre (High Modulus Polyethylene), LCP fibre (Liquid Crystal Polymer), Aramid fibre (Aromatic Polyamide)
Outer layer 3 protective of intermediate layer 2 consisting of fibre with high resistance to abrasion between fibres and in contact with metal surfaces, particularly polyolefin or polysteel.

These cords are manufactured using techniques known for manufacture of common mixed cords made of steel and polyolefin, where the latter plays a protective function of steel.

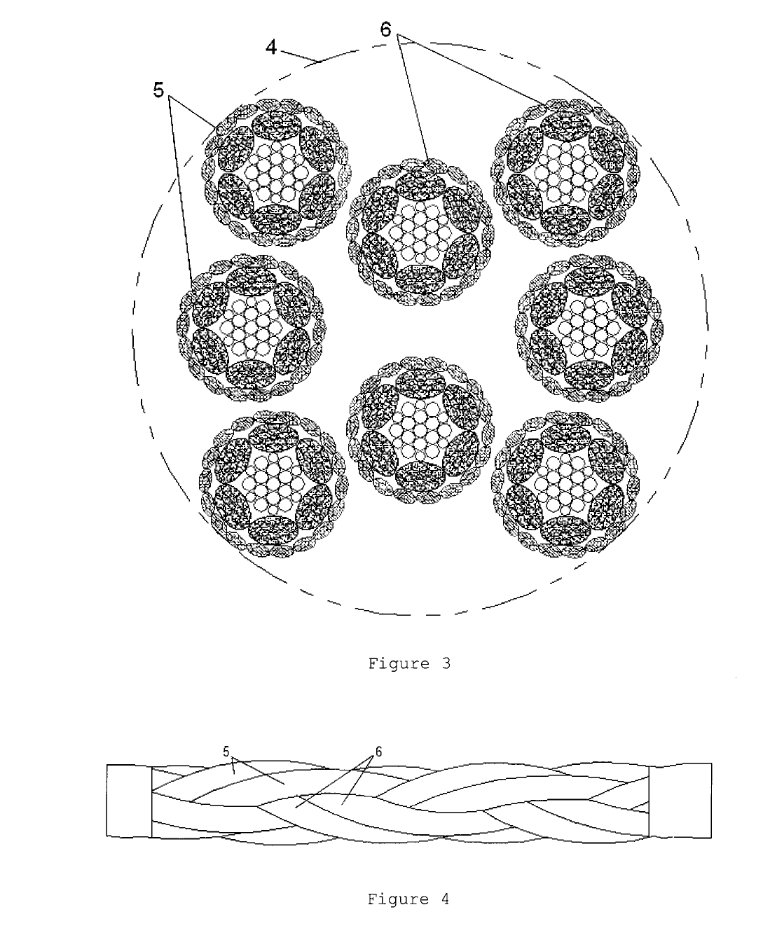

As depicted in FIGS. 3 and 4, this cord has a preferred application in a hybrid cable 4 of 8 strands (4×2) twisted. In its construction, using techniques already known two pairs of cords with twist direction Z (right) 5 and two pairs of cords with twist direction S (left) 6 are placed.

Cords with Z 5 twist are composed of fibres with spinning in S and steel cord in S. Cords with S twist are composed of fibres with spinning in Z and steel cord in Z.

This cord can also be applied to any other type of hybrid cable showing another construction, in braided cables or twisted cables.

1. Hybrid cord characterized by being composed of 3 layers and elements:
steel cord in the inner layer (1);
high module and high toughness fibre in the intermediate layer (2);
polysteel or polyolefin fibre in the outer layer (3).

2. Hybrid cord according to previous claim characterized by steel cord in the inner layer (1) is formed by steel wire galvanized or not, spirally arranged.

3. Hybrid cord according to claim 1 characterized by a high-module and high toughness fibre in the intermediate layer (2) is one among:
HPME fibre (High Modulus Polyethylene)
LCP fibre (Liquid Crystal Polymer)
Aramid fibre (Aromatic Polyamide)

4. Hybrid cord according to claim 1 characterized by the external element (3) fibre being a polyolefin fibre or polysteel high resistant to abrasion between fibres and in contact with metal surfaces.
